(19) United States
(12) Patent Application Publication
(10) Pub. No.: US 2008/0189393 A1
(43) Pub. Date: Aug. 7, 2008

(54) Remote Access to Secure Network Devices

(76) Inventor: Michael J. WAGNER, Fishers, IN (US)

Correspondence Address: OVERHAUSER LAW OFFICES, LLC;PAUL B. OVERHAUSER, 737 W. GREEN MEADOWS DRIVE, SUITE 300, GREENFIELD, IN, 46140, US

(21) Appl. No.: 12/108,439

(22) Filed: Apr. 23, 2008

Related U.S. Application Data
(63) Continuation of application No. 11/534,462, filed on Sep. 22, 2006.

(51) Int. Cl. G06F 15/16

(52) U.S. Cl. 709/218

(57) ABSTRACT

An illustrative communication system provides remote access to target devices located behind a firewall or other network security gateway. The system includes an internal processor and target devices coupled to a network located inside the gateway, and an external processor and clients coupled to a network located outside the network security gateway, for example the Internet. The internal processor includes an application and a database containing the internal processor node number, the shared secret, and a static IP address of the external processor. The external processor includes an application and database containing the internal processor node number, the shared secret, port to port to target device address mapping, and authentication data for clients. Upon activation the internal processor initiates a persistent TCP session with the external processor. Client access to the targeted devices is provided upon a client connecting to a port of the external processor, the port associated with a target device. Multiple logical sessions between various clients and targeted devices are supported over and transparent to the single persistent TCP session.

### CROSS-REFERENCE TO RELATED APPLICATIONS

This application is a continuation of U.S. patent application Ser. No. 11/534,462, filed Sep. 22, 2006.

### BACKGROUND

The present invention relates to remote access to network devices, and particularly, to remote access to a target device located behind an uncooperative firewall or other gateway providing security to a network.

Remote access of a target device can pose a number of challenges, especially if the target device is connected to a network, for example a local area network (LAN), the target device is located inside a network security gateway, and point of remote access is located outside of the gateway. A gateway such as a firewall or network address translation (NAT) device implements security policies that restrict outside access of devices located inside the gated network. Several layers of security may be implemented. For example, firewalls are often configured to prevent computers or other processors that are outside the firewall from connecting to any target device inside the firewall, often regardless of whether the IP addresses of the devices are public, non-public, dynamic, or static. Similarly, NAT devices provide dynamic or non-public IP addresses for devices inside the firewall; therefore, outside processors are unable to initiate communication with a target device having an IP address unknown to outside processors. Additionally, filtering may provide examination of data packets to allow or prevent transport of packets utilizing certain network application protocols, e.g. HTTP, or to allow or prevent transport of packets originating from or directed to particular preconfigured IP addresses.

To support access of networked target devices from clients located outside the gateway, one of several solutions is often implemented. One solution is to construct a virtual private network (VPN); however, the configuration of the gateway may not be accessible and yet generally must be set to allow a VPN, and VPN applications generally must be installed on both the outside client and the inside target device. Another solution is to specify and configure a port of the gateway to allow communication with a target device even when the communication is initiated by an outside client; however, the external IP address of the gateway or target device may change and so configuring a port can give rise to security vulnerabilities and that may violate the security practices for the network. Another solution is to provide an external IP address and port number mapped to the internal IP address for the target device; however, some gateways don't support such mapping, and even if the gateway does, such mapping may violate the security practices for the network. Yet another solution is to install a reverse connection application on the inside target device. The application initiates a reverse connection with the outside client periodically or upon receiving an e-mail request; however, some target devices may not be accessible to install such a reverse connection application; the IP address of the outside client may be non-public or dynamic; and such applications generally only support one communication connection and access to only one target device.

### SUMMARY

The present invention may comprise one or more of the following features or combinations thereof. An illustrative embodiment of a system for communicating between a client coupled to a first network and first and second target devices coupled to a second network, the first and second network including a secure gateway between the networks, includes an internal processor having a network adapter coupled to the second network; an external processor having a network adapter coupled to the first network, the network adapter including a plurality of ports; and code associated with the internal processor and the external processor, the code enabling the internal processor to initiate a persistent first communication connection with the external processor at a first one of the plurality of ports, to map a second one of the plurality of ports to the first one of the plurality of ports to an internal network address of the first target device, and to map a third one of the plurality of ports to the first one of the plurality of ports to an internal network address of second target device; and, upon receiving a communication from the client on the second one of the plurality of, the code enabling: the external processor to authorize a second communication connection with the client; the internal processor to initiate a third communication connection with the first target device; and the internal and external processors to enable a logical fourth communication connection between the client and the first target device using the first, second, and third communication connections. The system wherein the code further enables the internal and external processors to concurrently multiplex within and transparent to the transport layer a plurality of logical communication sessions between the client and the first and second target devices, the plurality of logical communication sessions supported over the first communication connection.

The system further including a database associated with the external processor, the database including a data structure adapted to store data for authenticating the client and the internal processor. The system wherein the data structure is adapted to store data for authenticating the client includes structure adapted to store at least one of a virtual key fob and network address of the client. The system further including a database associated with the external processor, the database including a data structure adapted to store a node address and shared secret for the internal processor. The system further including a database associated with the external processor, the database including a data structure adapted to map the second and third one of the plurality of ports to the internal processor to the first and second target device network sockets, respectively. The system further including a database associated with the internal processor, the database including a data structure adapted to store a network address and port number of the external processor and data for authenticating the internal processor. The system wherein the first target device is at least one of a process controller, an energy use or management device, and a building automation device. The system wherein the third communication connection includes an intermediate communication device.

An illustrative embodiment of a communication device for providing communication between clients located outside of a network gateway and target devices located inside of the network gateway, includes a processor; a network adapter coupled to the processor; and code associated with the processor and network adapter, the code including a shared secret, a network address and port number for a first client, and executable instructions; and wherein the code enables: the processor to initiate a first communication connection with the first client located outside of the network gateway, the first communication connection including a persistent transport layer session; the processor to initiate a second communication connection with a first target device; and upon a second client communicating with the first client and requesting access to the first target device, the processor to enable a logical third communication connection between the second client and the first target device using the first and second communication connection. The code further enabling upon a third client communicating with the first client and requesting access to a second target device, the processor to initiate a fourth communication connection with a second target device; and the processor to enable a logical fifth communication connection between the third client and the second target device using the first and fourth communication connection.

The communication device wherein the third and fifth communication connections can be concurrently supported as logical sessions within and transparent to the transport layer of the first communication connection. The communication device wherein the first communication connection includes a TCP session; and the network address includes an IP address. The communication device further including a database associated with the processor including data structure adapted to store the network address of the first client and the shared secret used to authenticate the first client. The communication device wherein the first target device is at least one of a process controller, an energy use or management device, and a building automation device. The communication device wherein the second communication connection includes an intermediate communication device.

An illustrative embodiment of a data storage medium includes processor readable code enabling: a first internal processor coupled to a first network to initiate a first communication connection with an external processor, the external processor coupled to a second network that is coupled to the first network by a first gateway, the first gateway securing the first network from access over the second network, the first communication connection including a persistent transport layer session; the external processor to authorize a second communication connection with a first client upon the first client connecting to a first port of the external processor; the external processor to map the first port to an internal network address and port of the first target device, the first target device coupled to the first network; the external processor to verify authorization of the first client to access the first target device; the first internal processor to initiate a third communication connection with the first target device subsequent to the external processor authorizing the first client to access the first target device; and the external and the first internal processors to enable a logical fourth communication connection using the second and third communication connections and within and transparent to the transport layer of the first communication connection.

The data storage medium wherein the processor readable code further enables: a second internal processor coupled to a third network to initiate a fifth communication connection with the external processor, the external processor coupled to a second network that is coupled to the third network by a second gateway securing the third network from access over the second network, the fifth communication connection including a persistent transport layer session; the external processor to authorize a sixth communication connection with the first client upon the first client connecting to a second port of the external processor; the external processor to map the second port to an internal network address and port of a second target device, the second target device coupled to the third network; the external processor to verify authorization of the first client to access the second target device; the second internal processor to initiate a seventh communication connection with the second target device subsequent to the external processor authorizing the first client to access the second target device; and the external and second internal processors to enable a logical eighth communication connection using the six and seventh communication connections and within and transparent to the transport layer of the fifth communication connection.

The data storage medium wherein the processor readable code further enables: the external processor to establish a fifth communication connection with the first client upon the first client connecting to a second port of the external processor; the external processor to map the second port to an internal network address and port of a second target device, the second target device coupled to the first network; the external processor to verify authorization of the first client to access the second target device; the first internal processor to initiate a sixth communication connection with the second target device subsequent to the external processor authorizing the first client to access the second target device; and the external and a first internal processors to initiate a logical seventh communication connection using the fifth and sixth communication connections and within and transparent to the transport layer of the first communication connection. The data storage medium wherein the logical fourth and seventh communication connections can be concurrently supported with the transport layer of the first communication connection. The data storage medium wherein the third communication connection includes an intermediate communication device.

The data storage medium wherein the processor readable code further enables: the external processor to authorize a fifth communication connection with one of the first client and a second client upon the one of the first client and the second client connecting to a second port of the external processor, the first client and the second client coupled to the second network; the external processor to map the second port to an internal IP address and port of the second target device, the second target device coupled to the first network; the external processor to verify authorization of the one of the first client and the second client to access the second target device; the first internal processor to initiate a sixth communication connection with the second target device subsequent to the external processor authorizing the one of the first client and the second client to access the second target device; and the internal and external processors to enable a logical seventh communication connection using the first, fifth, and sixth communication connections; and wherein the logical fourth and seventh communication connections can be concurrently supported within the transport layer of the first communication connection.

The data storage medium wherein the processor readable code includes data structures associated with the external processor and the internal processor; the data structure associated with the external processor is adapted for storing the node number of the internal processor, a shared secret, and information for enabling authentication of the first client; and the data structure associated with the internal processor is adapted for storing the shared secret and the network address and a port number of the external processor. The data storage medium wherein the data structure associated with the external processor is adapted for mapping a port of the first client to a network address and port of the first target device. The data storage medium wherein the second network includes the Internet.

An illustrative embodiment of a method of providing a reverse network connection through a network gateway securing a first network from access over a second network includes assigning a node number to an internal processor coupled to the first network; providing to the internal processor a network address and connection port number of an external processor coupled to the second network; providing to the external processor the node number of the internal processor and a plurality of network addresses corresponding to a plurality of target devices coupled to the first network; and mapping in the external processor each of a plurality of ports of the external processor to the contact port number to one of the plurality of network addresses.

The method further including providing a shared secret to both the internal and external processors. The method further including the internal processor authenticating the external processor with the shared secret; and the internal processor initiating a persistent transport layer session with the external processor. The method further including receiving at a first one of the plurality of ports of the external processor, an access request from a first client coupled to the second network; the external processor authenticating the first client; the external processor and verifying authorization of the first client to access a first target device logically associated by the mapping with the first one of the plurality of ports; and authorizing a first communication connection between the first client and the external processor.

The method further including the external processor sending over the persistent transport layer session an open command to the internal processor, the open command including the network address for the first target device; the internal processor initiating a second communication connection between the internal processor and the first target device; and enabling a logical third communication connection between the first client and the first target device using the first communication connection, the persistent transport layer session, and the second communication connection.

The method further including receiving at a second one of the plurality of ports of the external processor, an access request from a second client coupled to the second network; the external processor authenticating the second client; the external processor and verifying authorization of the second client to access a second target device logically associated by the mapping with the second one of the plurality of ports; and authorizing a fourth communication connection between the second client and the external processor.

The method further including the external processor sending over the persistent transport layer session an open command to the internal processor, the open command including the network address for the second target device; the internal processor initiating a fifth communication connection between the internal processor and the second target device; and enabling a logical sixth communication connection between the second client and the second target device using the fourth communication connection, the persistent transport layer session, and the fifth communication connection, the logical sixth communication connection capable of being supported concurrent with the third communication connection.

The method wherein the enabling the logical third and sixth communication connections concurrently include the internal and external processor assigning a first logical session ID for controlling the data stream between a first and second communication connections and assigning a second logical session ID for controlling the data stream between the fourth and fifth communication connections, the first or second logical session IDs encapsulated within the respective data stream segments that are multiplexed over the persistent transport layer session.

An illustrative embodiment of a system for providing access to a first network by a client coupled to a second network, the first and second networks including a secure gateway between the networks, includes an internal processor having a network adapter coupled to the first network; an external processor having a network adapter coupled to the second network; an energy management device coupled to the first network; the internal processor adapted to initiate a persistent communication connection with the external processor; the internal processor and external processor adapted to enable the client to communicate with the energy management device over the persistent communication connection, the enabling initiated upon the external processor receiving a communication from the client.

These and additional features of the disclosure will become apparent to those skilled in the art upon consideration of the following detailed description of the illustrative embodiments.

### BRIEF DESCRIPTION OF THE DRAWINGS

FIG. 1 is a block diagram of an illustrative embodiment, including multiple internal processors located inside secured networks, and an external processor and multiple clients located outside the secured networks;

FIG. 2 is a block diagram of a portion of the illustrative embodiment of FIG. 1, including illustrative sequence and paths of communication connections;

FIG. 3 shows illustrative data structures associated with the illustrative embodiment of FIG. 1;

FIG. 4 is a flow chart of an illustrative algorithm for configuring the illustrative embodiment of FIG. 1;

FIG. 5 is a flow chart of an illustrative algorithm associated with the external processor of the illustrative embodiment of FIG. 1; and

FIG. 6 is a flow chart of an illustrative algorithm associated with the internal processors of the illustrative embodiment of FIG. 1.

### DESCRIPTION OF THE ILLUSTRATIVE EMBODIMENTS

For the purposes of promoting and understanding the principles of the invention, reference will now be made to one or more illustrative embodiments illustrated in the drawings and specific language will be used to describe the same. It will nevertheless be understood that the one or more illustrative embodiments are not intended to limit the scope of the claims, but rather to disclose one or more illustrative embodiments among a broader range of possible embodiments that may be within the scope of the claims.

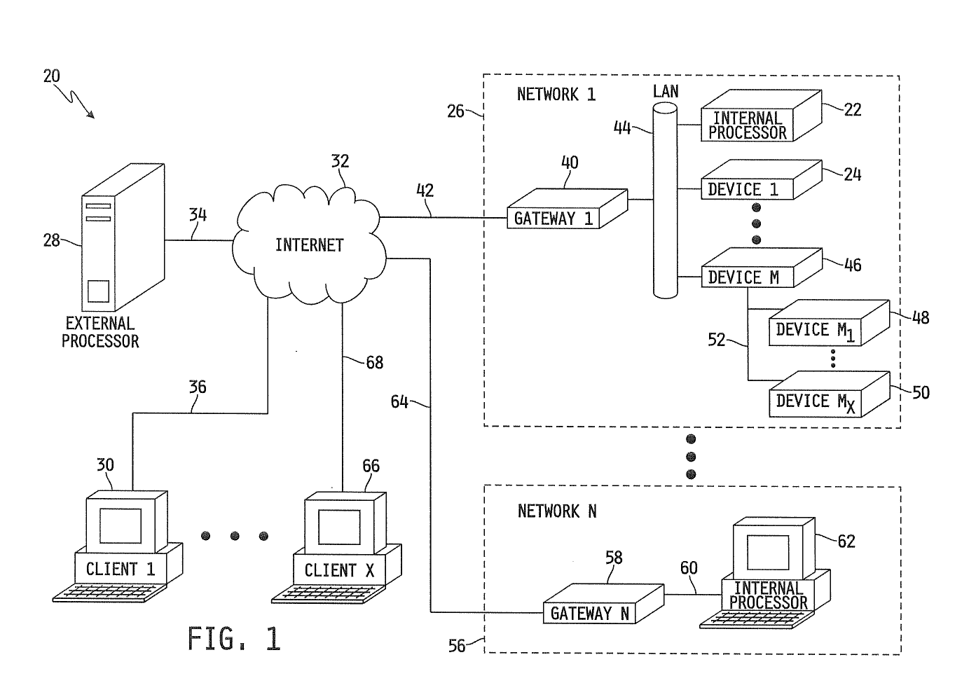

Referring to FIG. 1, an illustrative embodiment of a system 20 includes an internal processor 22 and a target device 24 located within a network 26, and an external processor 28 and a client 30 located outside of the network 26. The external processor 28 and the client 30 are coupled by a communication system, for example a wide area network (WAN) such as the Internet 32. The communication links 34 and 36 coupling the external processor 28 and the client 30 to the Internet 32 may be wired or wireless links.

The network 26 includes a gateway 40 that is coupled to the Internet 32 by a wired or wireless communication link 42. The gateway 40 may include a firewall, network address translation (NAT) device, router, server, processor, or other security device adapted to restrict access over the communication link 42 to devices located within the network 26. The network 26 includes a network infrastructure, for example a local area network (LAN) 44, that couples the gateway 40 to the internal processor 22 and the target device 24.

The network 26 may also include a quantity M of additional target devices 46 that are also coupled to the LAN 44. One or more additional target devices 46 may also function as a server, router, or other communication or controlling function for a quantity M_{X} of additional target devices 48 and 50. The target devices 48 and 50 can be coupled to the target device 46 by a communication link 52. The LAN 44 and the communication link 52 can include wired and wireless communication elements.

The illustrative embodiment of the system 20 also includes a quantity N of additional networks 56. Each of the additional networks 56 can include a gateway 58, LAN 60, and internal processor 62. The gateway 58 can be coupled to the Internet 32 by a communication link 64. The system 20 can also include a quantity X of additional clients 66 that are coupled to the Internet 32 by one or more communication links 68.

The internal processors 22 and 62 are each adapted to initiate a persistent communication connection with the external processor 28, for example using a transport layer protocol, such as a TCP communication session. The external processor 28 is adapted to authorize the persistent communication connections upon authentication of the internal processors 22 and 62. Despite the security protocols provided by the gateway 40 and 58, the persistent communication connections between the external processor 28 and the internal processors 22 and 62 provide a communication pathway for the clients 30 and 66 to access the target devices 24, 46, 48, and 50 and the internal processor 62.

The external processor 28 is adapted to authenticate the clients 30 and 66, and at least one of the internal processor 22 and external processor 28 is adapted to initiate logical communication connections, for example virtual communication sessions, within and transparent to the persistent communication connection between the external processor 28 and the internal processor 22. For example, the client 30 initiates communication with the external processor 28 and requests access to the target device 24. The external processor 28 can authenticate the client 30 and can verify that the client 30 is authorized to access the target device 24. Upon successful authentication and verification, the external processor 28 sends a command to the internal processor 22 to initiate a logical communication connection between the client 30 and internal processor 22, the logical communication connection using the persistent communication connection. The internal processor 22 responds by initiating a communication connection between the internal processor 22 and the target device 24. Via the logical communication connection between the external processor 28 and the internal processor 22 and the communication connection between the internal processor 22 and the target device 24, the client 30 is provided access to send and receive data streams with the target device 24.

In the illustrative embodiment of the system 20, the target devices 24, 46, 48, and 50 include processors such as an energy use or management device, for example an i.Lon or LonWorks (registered trademarks of Echelon Corp.) server or other devices available from Echelon Corp., of San Jose, Calif.; however, the target devices 24, 46, 48, and 50 may include any device capable of receiving or providing data, for example, but not limited to, a computer, a processor, a controller, a PLC, a server, a process controller, a building automation device, a security device, and a communication device.

Advantageously, in the illustrative embodiment of the system 20, the internal processor 22 initiates the persistent communication connection with the external processor 28 and internal processor 22 and also initiates the communication connection with the target device 24, therefore, the pre-existing protocols of the gateway 40 generally require no modification and neither the client 30 nor the external processor 28 require an outside IP address for the gateway 40, the internal processor 22, or the target device 24. Additionally, in the illustrative embodiment of the system 20, the remote access to the target device 24 can be initiated by the client 30 without having to install applications specifically supporting remote access or reverse connections on the client 30 and the target device 24. The client 30 can initiate access by using an IP address for the external processor 28 and a port number of the actual processor 28 that is associated with the target device 24. Additionally, the client 30 initiates access to the external processor 28, so the client 30 may use a dynamic or nonpublic IP address. Additionally, any communication protocol can be used between the client 30 and the external processor 28 and between the internal processor 22 and the target device 24 because the data streams originating from the client 30 and the target device 24 are transported in a virtualized session over the persistent communication connection between the external processor 28 and the internal processor 22. The persistent communication connection is selected to be a protocol allowed by the gateway 40, for example using a transport layer protocol such as a standard TCP session. Additionally, because the internal processor 22 is located inside the gateway 40, the client 30 can also access targeted devices 48 and 50 which are located inside the gateway 40 but are not necessarily coupled directly to the LAN 44. For example, the internal processor 22 can initiate a communication connection with targeted devices 48 and 50 through an intermediate device 46 that is coupled to the LAN 44.

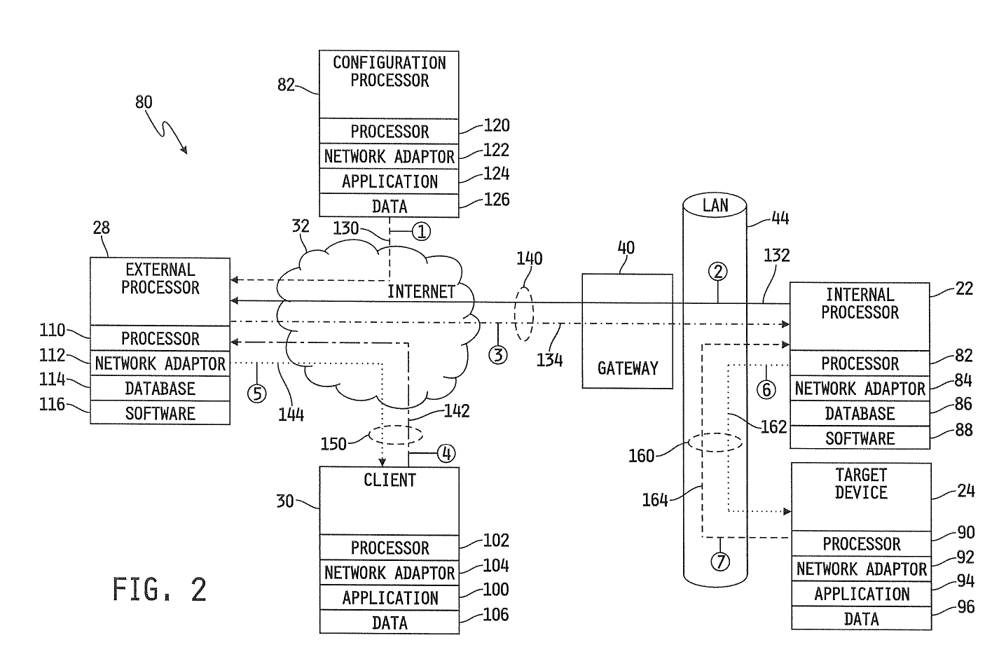

Referring now to FIG. 2, an illustrative portion 80 of the illustrative embodiment of the system 20 of FIG. 1 illustrates the sequence and pathways of various communication connections between and across various elements, including the internal processor 22, the target device 24, the external processor 28, the client 30, the Internet 32, the gateway 40, and a configuration processor 82.

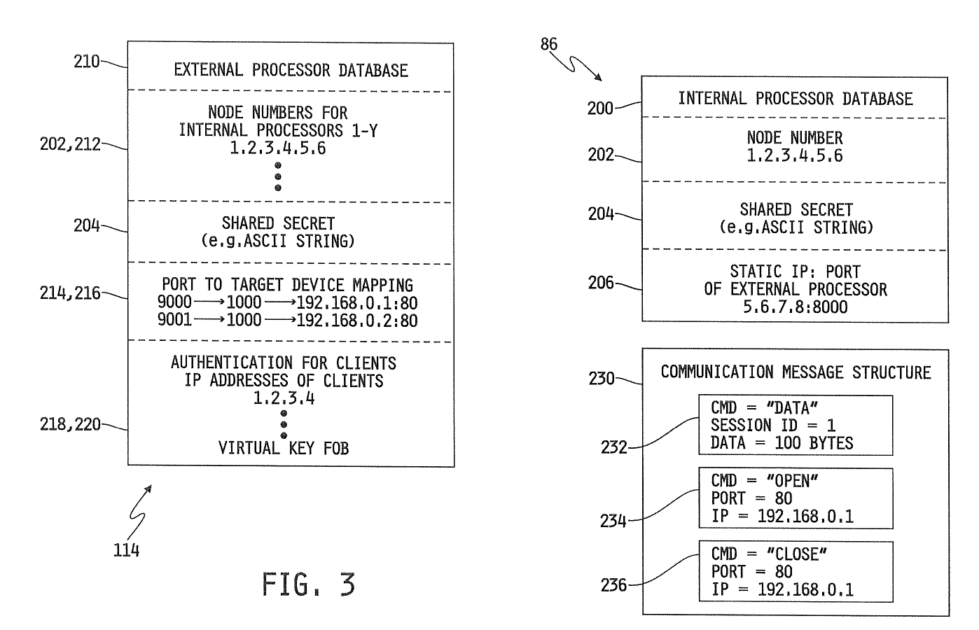

The internal processor 22 generally includes a microprocessor 82, a network adapter 84 coupled to the LAN 44, a database 86, and software 88. The database 86 and software 88 are at times collectively referred to as processor readable code, the code enabling the internal processor 22 to provide various aspects of the disclosure. The internal processor 22 can be, for example but not limited to, a processor, computer, server, or router having an operating system (not shown), for example but not limited to, such as Linux, UNIX, and Windows and supporting communication across networks such as the LAN 44, the gateway 40, and the Internet 32. The microprocessor 82 is of sufficient processing power to support communication with the external processor 28 and the target device 24, for example at or above 100 MHz. In one illustrative embodiment of database 86 shown in FIG. 3, a data structure 200 includes storage for a node number 202 that is assigned to the internal processor 22, a shared secret 204, and the public network address and a specific port number 206 of the external processor 28.

As discussed above, the target device 24 of the illustrative embodiment is an energy use or management device for a building or other facility; however, the target device 24 may alternatively be any device capable of receiving or providing a data stream. The target device 24 generally includes a processor 90, a network adapter 92 coupled to the LAN 44, an application 94, and data 96. The application 94 can be any application executable by the processor 90 and capable of providing a data stream over a communication link between the internal processor 22 and the data 96. For example, but not limited to, the application 94 may implement an HTTP related protocol such as a web server that is associated with the data 96. The data 96 may include typical data and processor executable code received from or deliverable to the client 30. An alternative embodiment of the target device 24 is illustrated by the internal processor 62 of FIG. 1, in which the internal processor 62 includes the target device of this disclosure.

The client 30 generally includes an application 100, a processor 102, a network adapter 104 coupled to the Internet 32, and data 106. The client 30 of the illustrative embodiment is a PC capable of executing an application 100 directed to, but not limited to, measuring, logging, analyzing, modeling, implementing, configuring, and/or controlling energy use and management devices and processes, for example, iLogger (a trademark of EnergyPro Services, Inc.), a software product available from EnergyPro Services, Inc., of Carmel, Ind.; however, the client 30 may alternatively be any device and application capable of receiving or providing a data stream over a communication link between the external processor 28 and the data 106. Additionally, the application 100 can be any application executable by the processor 102 and capable of providing a data stream between the external processor 28 and the data 106. For example, but not limited to, the application 100 may implement an HTTP related protocol such as a web server associated with the data 106. The data 106 may include typical data and may also include processor executable code received from or deliverable to the target device 24.

The external processor 28 generally includes a microprocessor 110, a network adapter 112 coupled to the Internet 32, a database 114, and software 116. The database 114 and software 116 are at times collectively referred to as processor readable code, the code enabling the external processor 28 to provide various aspects of the disclosure. The external processor 28 can be, for example, but not limited to, a processor, computer, server, or router having an operating system (not shown), for example but not limited to Linux, UNIX, and Windows, and supporting communication across networks such as the Internet 32, the gateway 40, and the LAN 44. The microprocessor 110 is of sufficient processing power to support communication with the internal processor 22, the client 30, and the configuration processor 82, for example at or above 100 MHz. For the purposes of this disclosure, the external processor 28 can also be referred to as a “client” relative to the internal processor 22.

In one illustrative embodiment of database 114 shown in FIG. 3, a data structure 210 includes storage for node numbers 202 and 212 that are assigned to the internal processors 22 and 62 (FIG. 1), a shared secret 204, mapping 214 logically relating one port, for example 9000, of the external processor 28 to one port, for example 1000, of the external processor 28 to which the internal processor 22 is connected, and to the internal network address and port number, for example 192.168.0.1:80, of the target device 24, mapping 216 logically relating another port, for example 9001, of the external processor 28 to one port, for example 1000, of the external processor 28 to which the internal processor 22 is connected, and to the internal network address and port number, for example 192.168.0.2:80, of the target device 46 (FIG. 1), and authentication data for the client 30, for example a static or dynamic public IP address 218, such as 1.2.3.4, and a virtual key fob code 220 associated with the client 30; it being understood that the specific port numbers and network addresses are illustrative and not limiting, and the data structure 210 may include only one or more than two node numbers, only one or more than two mappings, and alternative forms of authentication data for the client 30.

The configuration processor 82 generally includes a processor 120, a network adapter 122 coupled to the Internet 32, an application 124, and data 126. The configuration processor 82 of the illustrative embodiment is a PC capable of executing an application 100 implementing an HTTP related protocol such as a web browser that is capable of accessing the database 114 of the external processor 28 over the Internet 32. For example, the application 100 enables the configuration processor 82 to provide a data stream between the data 126 and the database 114 in order to deliver or retrieve elements of the database 114 via the configuration processor 82. The configuration processor 82 may alternatively be any device and application capable of receiving or providing a data stream over a communication link between the external processor 28 and the data 126. The data 126 may include typical data and may include processor executable code received from or deliverable to the external processor 28.

Still referring to FIG. 2, the illustrative portion 80 of the illustrative embodiment of the system 20 of FIG. 1 includes an illustrative sequence and illustrative pathways of various communication connections between and across the above discussed elements of the system 20. In order to provide or supplement the database 114, a user or automated process of the configuration processor 82 can initiate a communication connection 130 between the configuration processor 82 and the external processor 28, for example across the Internet 32 and directed to a port of external processor 28 designated for configuration communication. The database 114 and the software 116 of the external processor 28 may include data or other code for authenticating the configuration processor 82, for example by validating a password or in IP address provided by the configuration processor 82. Additionally, the external processor 28 may only allow a data stream with the database 114 to be established through the communication connection 130 if the connection 130 is initiated at a predetermined port of the external processor 28 that is designated for configuration communication. The connection 130 can be terminated by either the external processor 28 or the configuration processor 82 upon completion of the data transfer. The configuration processor 82 and the data connection 130 may also be used to initiate, terminate, or otherwise monitor or control the execution of the software 116 and other aspects of this disclosure associated with the external processor 28.

Upon execution of the software 88, the internal processor 22 automatically and periodically sends an initiation communication 132 to the IP address and port number 206 (FIG. 3) of the external processor 28 as specified in the database 86. The initiation communication 132 is routed through the gateway 40 and the Internet 32. Upon receipt of the initiation communication 132, the external processor 28 authenticates the internal processor 22 and responds with reply communication 134. Upon successful authentication, the internal processor 22 and the external processor 28 cooperate to provide a persistent communication connection 140, for example, but not limited to, a singular transport layer session such as a TCP session which originated with the initiation communication 132 from the internal processor 22.

Upon execution of the application 100, the client 30 sends an initiation communication 142 to the IP address of the external processor 28 and to a port number, for example 9000, corresponding to the target device 24 intended to be accessed by the client 30. After authenticating the client 30, verifying the client 30 has permission to access the target device 24, and verifying the internal processor 22 is available through the persistent communication connection 140, the external processor 28 sends reply communication 144 establishing a communication connection 150 between the external processor 28 and the client 30. The communication connection 150 may be any form of data stream supported by the application 100, for example, but not limited to, utilizing a transport layer protocol different that that used for communication connection 140, and communication connection 150 may include an HTTP protocol.

After the communication connection 150 is successfully established, the external processor 28 instructs the internal processor 22 to open a communication connection 160 between the internal processor 22 and the target device 24. The internal processor 22 sends an initiation communication 162 to the target device 24, and the target device 24 provides a response communication 164 in order to establish the communication connection 160. The communication connection 160 may be any form of data stream supported by the application 94, for example, but not limited to, utilizing a transport layer protocol different that that used for communication connection 140, and communication connection 160 may include an HTTP protocol.

After the successfully establishing the communication connections 150 and 160, the external processor 28 and internal processor 22 provide a virtual communication connection between the client 30 and the target device 24 by providing a logical communication connection, for example a virtual TCP session, over the persistent communication connection 140. The features of the logical communication connection are transparent to the client 30 and the target device 24 because the client 30 is only required to support the communication connection 150 and the target device 24 is only required to support the communication connection 160.

Referring to FIG. 3, the illustrative virtual communication data structure 230 enables the external processor 28 and the internal processor 22 to support multiple logical communications sessions across a single, persistent communication connection 142. For example, the data structure 230 and enabling aspects of the software 88 and 116 provide a virtual communication protocol for multiplexing multiple logical sessions within the real transport layer communication protocol of the communication connection 140. For example, the virtual communication protocol may utilize features of TCP or another communication protocol yet be transparent to the real transport layer communication protocol, which may be, for example, a TCP session. For example, the illustrative data structure 230 provides three types of encapsulated messages, data message 232, open communication message 234, and close communication message 236. Advantageously, the virtual communication protocol may not require data packet reliability and sequencing features sense the real communication protocol of the communication connection 140 can be selected to provide such features.

The illustrative data message 232 includes data structure for a command field, specifying the type of message, a session ID field, specifying the logical session number, and a data field, containing at least a portion of the data stream to be transported between the client 30 and the target device 24. The illustrative open communication message 234 includes data structure for a command field, specifying the type of message, a port field, specifying the port of the target device 24 to direct the communication to, and an IP address field, specifying the local IP address of the target device 24 on the LAN 44. The illustrative close communication message 236 includes data structure for a command field, specifying the type of message, a port field, specifying the port of the target device 24 to close the communication with, and an IP address field, specifying the local IP address of the target device 24 on the LAN 44.

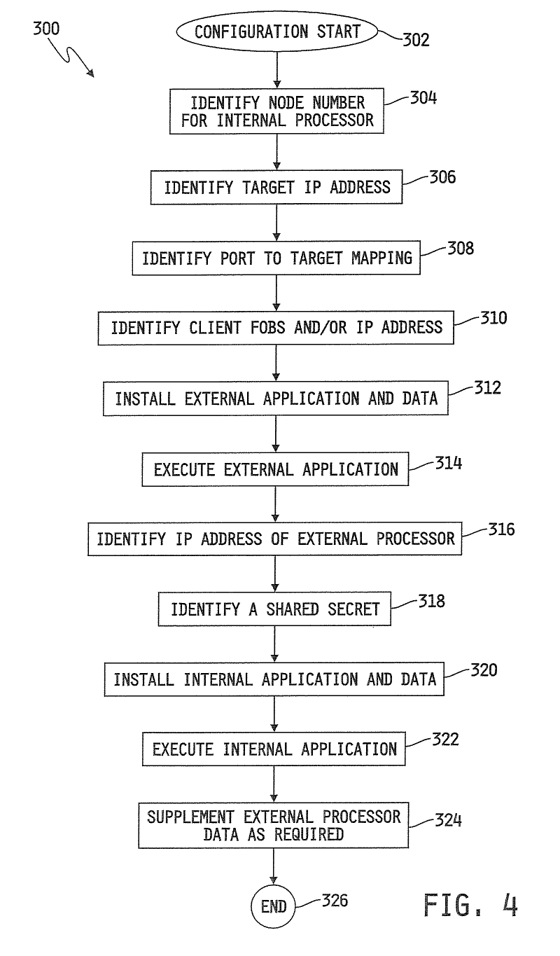

FIG. 4 illustrates an illustrative embodiment of an algorithm 300 for providing and operating the illustrative embodiment of the system 20. Execution of the algorithm begins at step 302. At step 304, the node numbers 202 and 212 of the internal processors 22 and 62, and for storage in the data structure of database 86 and 114 (FIG. 2 and 3), are identified. At step 306, the internal IP addresses for the target devices 24, 46, 48, 50, and 62 are identified. At step 308, the mappings 214 and 216 for storage in the data structure of database and 114 (FIG. 2 and 3) are identified. For example, one such mapping could be: port number 9000, a port of the external processor 28 that corresponds to the connection 150 with the client 30; port number 1000, a port of the external processor 28 that corresponds to the connection 140 with the internal processor 22; and network address and port number 192.168.0.1:80 that corresponds to the connection 160 with the target device 24. At step 310, IP addresses 218 and/or virtual key fob codes 220 of the clients 30 and 66 for storage in the data structure of database 114 and in the data 106 of the clients 30 and 66 are identified. At step 312, the software 116 is installed in the external processor 28 and the database 114 is configured, for example using the configuration processor 82 as discussed above. At step 314, or at a subsequent step, the software 116 is executed.

At step 316, the public IP address of the external processor 28 for storage in the data structure of database 86 (FIGS. 2 and 3) is identified. At step 318, a shared secret, for example an ASCII string, for storage in the data structure of databases 86 and 114 (FIG. 2 and 3) is identified. At step 320, the software 88 is installed in the internal processors 22 and 62 and the database 86 is configured. At step 322, the software 88 is executed. The steps 320 and 322 may be completed by direct access to the internal processors 22 and 62, remotely by the external processor 28, or by other methods known in the art. At step 324, the database 114 and the software 116 of the external processor 28 may be supplemented as required, for example using the configuration processor 82. At the step 324, the database 86 and the software 88 of the internal processor 22 may be supplemented as required using methods known in the art. At step 326, the illustrative embodiment of the algorithm 300 for providing and operating system 20 is complete. The order and flow of steps 302-326 of the algorithm 300 are illustrative and in some cases may be changed without substantially impacting the operation of the system 20.

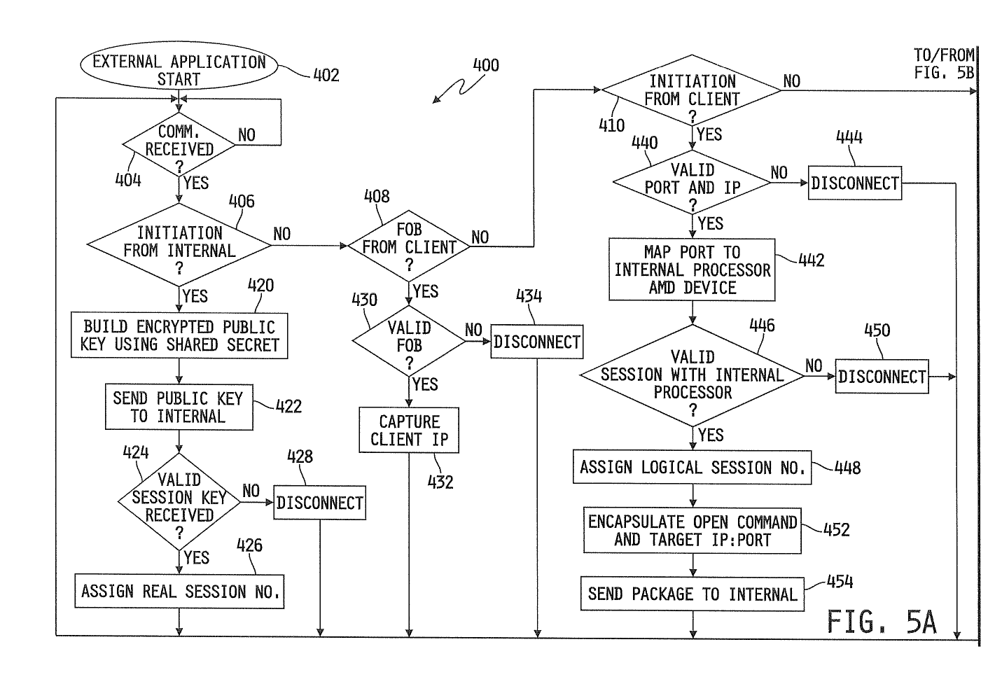

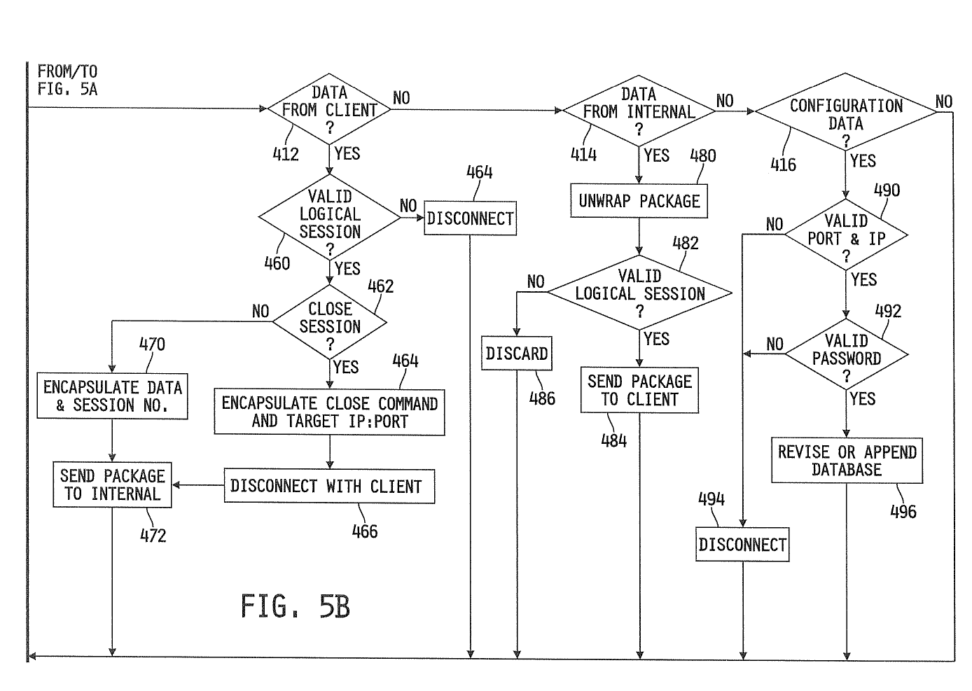

FIG. 5 illustrates an illustrative embodiment of an algorithm 400 associated with the external processor 28 of the illustrative embodiment of the system 20. The algorithm 400 may be implemented, for example and as illustrated in part in FIG. 2, by the software 116, the processor 110, and other applicable elements of the external processor 28. Execution of the algorithm 400 begins at step 402. At step 404, the processor 110 determines whether communication has been received by the network adapter 112. If so, execution of the algorithm 400 continues at step 406, otherwise execution returns to step 404.

At step 406, the processor 110 determines whether the received communication includes an initiation communication 132 from the internal processor 22 and, if so, whether the initiation communication 132 is received on a specific predetermined port number of the external processor 28. If so, execution of the algorithm 400 continues at step 420, else execution continues at step 408. At step 408, the processor 110 builds an encrypted public-key using the shared secret 204, for example the public key may be based on the shared secret 204 and encrypted using AES or other known encryption methods. At step 422, the processor 110 responds to the internal processor 22 with the reply communication 134, including sending the encrypted public key. At step 424, the processor 110 determines whether a valid session key has been received from the internal processor 22, the session key for encrypting the persistent communication connection 140, for example a singular TCP session. If a valid session key has been received, the algorithm 400 continues at step 426, else step 428 is completed. At step 426, the processor 110 assigns a real session number to the persistent communication connection 140, thereby also indicating the availability of communication with the internal processor 22. If step 428 is completed, communication with the internal processor 22 is terminated. After step 426 or step 428 is completed, execution of the algorithm 400 continues at step 404.

At step 408, the processor 110 determines whether the communication includes an initiation communication 142 at a port number corresponding to the client 30 that is presenting a virtual key fob. If so, execution of the algorithm 400 will continue at step 430, else step 410 will be completed. At step 430, the processor 110 will respond with a reply communication 144, receive the virtual key fob, and verify the presented key fob matches a virtual key fob code 220 stored in the database 114. If the presented virtual key fob is valid, execution of the algorithm 400 continues at step 432, else step 434 is completed. At step 432, the processor 110 captures the public IP address of the client 30 and stores it as an authenticating IP address 218 in the database 114, for example for a preset period of time. If step 434 is completed, the processor 110 terminates communication with the client 30. After either step 432 or step 434 is completed, execution of the algorithm 400 continues at step 404.

At step 410, the processor 110 determines whether the communication includes an initiation communication 142 from the client 30 and requesting access to one of the target devices 24, 46, 48, 50, and 62. If so, execution of the algorithm 400 will continue at step 440, else step 412 will be completed. At step 440, the processor 110 determines whether the initiation communication 142 was received from an authenticated IP address 118 of the client 30 and whether the client 30 has permission to access the target device 24 associated with the specific port to which the initiation communication 142 was directed. If so, step 442 is completed, else step 444 is completed. If step 444 is completed, the processor 110 terminates communication with the client 30 and execution of the algorithm 400 continues at step 404.

At step 442, the specific port to which the initiation communication 142 was directed is logically mapped to the internal processor 22 and to the target device 24 and a port number of the target device 24, as determined by the mappings 214 and 216 of the database 114. For example, as illustrated in FIG. 3, if the initiation communication 142 is received at a specific port, illustratively port 9000 of the external processor 28, then the mapping 214 will logically direct the access request to the internal processor 22, specified by the illustrative port 1000 of the external processor 28 to which internal processor 22 is connected, and to the target device 24, specified by the illustrative IP address and port number 192.168.0.1:80. At step 446, the processor 110 determines whether a valid communication session, persistent communication connection 140, presently exists for accessing the internal processor 22. If so, then step 448 is completed, else step 450 is completed. If step 450 is completed, the processor terminates the communication with the client 30 and execution of the algorithm 400 continues at step 404.

At step 448, the processor 110 assigns a logical session number to the virtual communication connection that is used to transport a data stream between the client 30 and the target device 24 over the persistent communication connection 140. At the step 452, the processor 110 encapsulates an open communication message 234 according to the illustrative data structure 230 (FIG. 3). The open communication message 234 includes the local IP address and port number to be used by the internal processor 22 to establish the communication channel 160 with the target device 24. At step 454, the processor 110 sends the encapsulated open communication message 234 to the internal processor 22 over the persistent communication connection 140. After step 454 is completed, execution of the algorithm 400 continues at step 404.

At step 412, the processor 110 determines whether the communication received includes a portion of the data stream to be transported from the client 30 to the target device 24. If so, then execution of the algorithm 400 continues at step 460, else step 414 is completed. At step 460, the processor 110 determines whether the data received from the client 30 is associated with a valid and active logical session number. If so, then step 462 is completed, else step 464 is completed. If step 464 is completed, the processor 110 terminates communication with the client 30 and the execution of the algorithm 400 continues at step 404.

At step 462, the processor 110 determines whether the data received from the client 30 is a request to terminate the virtual communication connection providing access to the target device 24. If so, step 464 is completed, else step 470 is completed. If step 464 is completed, the processor 110 encapsulates a close communication message 236 according to the illustrative data structure 230 (FIG. 3). The close communication message 236 includes the local IP address and port number to be used by the internal processor 22 to close the communication channel 160 with the target device. At step 466, the processor 110 terminates the communication connection 150 with the client 30.

If step 470 is completed, the processor 110 encapsulates a data communication message 232 according to the illustrative data structure 230 (FIG. 3). The data communication message 232 includes data contain a portion of the data stream to be transported from the client 32 the target device 24, and the logical session ID number to be used by the internal processor 22 to direct the data over the communication channel 160 and to the target device 24.

After either step 466 or step 470 is completed, at step 472, the processor 110 sends the encapsulated data communication message 232 or close communication message 236 to the internal processor 22 over the persistent communication connection 140. After step 472 is completed, execution of the algorithm 400 continues at step 404.

At step 414, the processor 110 determines whether the communication was received from the internal processor 22 and includes a portion of the data stream to be transported from the target device 24 to the client 30. If so, the execution of algorithm 400 continues at step 480, else step 416 is completed. At step 480, the processor 110 unwraps or otherwise parses the received communication, for example in accordance with the data communication message 232 of the data structure 230. At step 482, the processor 110 determines whether the data received from the internal processor 22 is associated with a valid and active logical session number. If so, then step 484 is completed, else step 486 is completed.

If step 486 is completed, the processor 110 terminates communication with the client 30 and the execution of the algorithm 400 continues at step 404. If step 484 is completed, the processor 110 sends the data, representing a portion of the data stream to be transported from the target device 24 to the client 30, to the client 30 over the communication channel 150 and in accordance with the communication protocol initiated by the client 30. After step 484 or step 486 is completed, execution of the algorithm 400 continues at step 404.

At step 416, the processor 110 determines whether the received communication was received from the configuration processor 82. If so, step 490 is completed, else the execution of algorithm 400 continues at step 404. At step 490, the processor 110 determines whether the communication was received at a valid port number of the external processor 28 that is specified for configuration, and whether the communication was received from an authenticated IP address. If so, then step 492 is completed, else step 494 is completed. At step 492, the processor 110 requests and validates a password or other shared secret provided by the configuration processor 82. If the password is valid, step 496 is completed, otherwise step 494 is completed. At step 496, the processor 110 revises or appends data associated with the database 114 with data received from the configuration processor 82, or provides data from the database 114 to the configuration processor 82, for example in accordance with instructions received from the configuration processor 82. If step 494 is completed, the processor 110 terminates communication with the configuration processor 82. After either step 494 or step 496 is completed, execution of the algorithm 400 continues at step 404. The order and flow of steps 402-496 of the algorithm 400 are illustrative and in some cases may be changed without substantially impacting the operation of the system 20.

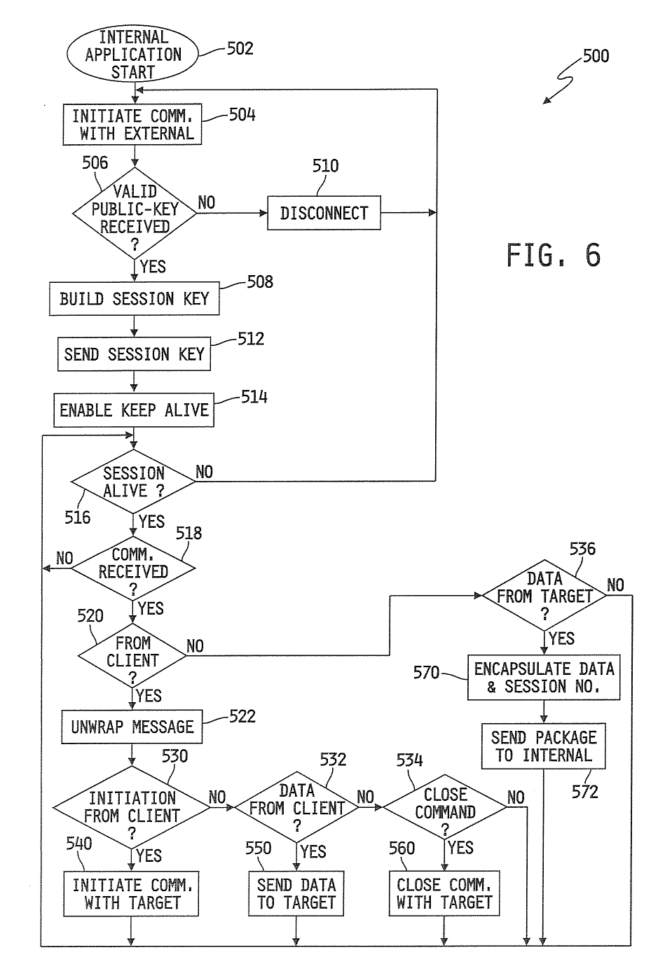

FIG. 6 illustrates an illustrative embodiment of an algorithm 500 associated with the internal processor 22 of the illustrative embodiment of the system 20. The algorithm 500 may be implemented, for example and as illustrated in part in FIG. 2, by the software 88, the processor 82, and other applicable elements of the internal processor 22. Execution of the algorithm begins at step 502. At step 504, the processor 82 directs an initiation communication 132 to the external processor 28 using the IP address and port number 206 specified in the database 86. At step 506, the processor 82 determines whether a valid encrypted public key, for example using the shared secret 204 and as discussed above for the algorithm 400, was received from the external processor 28 in a reply communication 134. If so, then step 508 is completed, else step 510 is completed. If step 510 is completed, the internal processor 22 terminates communication with the external processor 28 and execution of the algorithm 500 continues at step 504, for example after a predetermined delay, for example 10 seconds.

At step 508, the processor 82 builds a session key for encrypting the connection 140, for example an AES session key based on the received public key and the shared secret 204. At step 512, the processor 82 sends the session key to the external processor 28. At the step 514, the processor 82 enables a persistent communication connection 140 between the external processor 28 and the internal processor 22, for example a persistent, singular TCP session having the keep alive function activated.

At step 516, the processor 82 determines whether the persistent communication connection 140 between the internal processor 22 and the external processor 28 is still an active session. If so, then step 518 is completed, else step 504 is completed. At step 518, the processor 82 determines whether a communication has been received. If so, then step 520 is completed, else the execution of algorithm 500 continues at step 516. At step 520, the processor 82 determines whether the communication was received over the persistent communication connection 140. If so, then step 522 is completed, else step 536 is completed.

At step 522, the processor 82 unwraps or otherwise parses the received message, for example in accordance with the data structure 230 (FIG. 3) discussed above. At step 530, the processor 82 determines whether the received communication is an open communication message 234 sent by the external processor 28 in response to a client 30 request for access. If so, then step 540 is completed, else step 532 is completed. At step 540, the internal processor 22 establishes a communication channel 160 with the target device 24, the target device 24 specified by the IP address and port number contained within the open communication message 234. After step 540 is completed, execution of the algorithm 500 continues at step 516.

At step 532, the processor 82 determines whether the message received was a data communication message 232 sent by the external processor 28. If so, then step 550 is completed, else step 534 is completed. At step 550, the processor 82 identifies from the logical session ID number the communication channel 160 and target device 124 to which the data contained in the data communication message 232 is directed to. The processor 82 then sends the data to the target device 24 using the communication protocol established for the communication connection 160. After step 550 is completed, the execution of the algorithm 500 continues at step 516.

At step 534, the processor 82 determines whether the message received was a close communication message 236 sent by the external processor 28, for example subsequent to the client 30 requesting termination of access to the target device 24. If so, step 560 is completed, else execution of the algorithm 500 continues at step 516. At step 560, the processor 82 terminates the communication connection 160 with the target device 24 specified by the local IP address and port number contained within the close communication message 236. After step 560 is completed, execution of the algorithm 500 continues at step 516.

If at step 520, the processor 82 determined the received communication was not from the persistent communication connection 140, then at step 536, the processor 82 determines whether the received communication is a portion of a data stream received from the target device 24 and directed to the client 30. If so, then step 570 is completed, else execution of the algorithm 500 continues at step 516. At step 570, the processor 82 encapsulates the received data into a data communication message 232, including the appropriate logical session ID number associated with the logical communication connection between the target device 24 and a client 30. At step 572, the processor 82 sends the data communication message 232 to the external processor 28 over the persistent communication connection 140. After step 572 is completed, execution of the algorithm 500 continues at step 516. The order and flow of steps 502-572 of the algorithm 500 are illustrative and in some cases may be changed without substantially impacting the operation of the system 20.

While the invention has been illustrated and described in detail in the foregoing drawings and description, the same is to be considered as illustrative and not restrictive in character, it being understood that only illustrative embodiments thereof have been show and described and that all changes and modifications that are within the scope of the following claims are desired to be protected. For example, while the disclosure has utilized aspects of the TCP/IP protocols in discussing the illustrative embodiments, other transport layer and network layer protocols can be substituted. Similarly, network structures other than the Internet, a LAN, and a WAN can be substituted; and other authentication, verification, and encryption techniques or combinations other than those discussed in the disclosure can be substituted.

1. A system for communicating between a client coupled to a first network and first and second target devices coupled to a second network, the first and second network including a secure gateway between the networks, comprising:
an internal processor having a network adapter coupled to the second network;
an external processor having a network adapter coupled to the first network, the network adapter including a plurality of ports; and
code associated with the internal processor and the external processor, the code enabling the internal processor to initiate a persistent first communication connection with the external processor at a first one of the plurality of ports, to map a second one of the plurality of ports to the first one of the plurality of ports to an internal network address of the first target device, and to map a third one of the plurality of ports to the first one of the plurality of ports to an internal network address of second target device; and, upon receiving a communication from the client on the second one of the plurality of ports, the code enabling:
the external processor to authorize a second communication connection with the client;
the internal processor to initiate a third communication connection with the first target device; and
the internal and external processors to enable a logical fourth communication connection between the client and the first target device using the first, second, and third communication connections.

2. The system of claim 1, wherein the code further enables the internal and external processors to concurrently multiplex within and transparent to the transport layer of the first communication connection a plurality of logical communication sessions between the client and the first and second target devices, the plurality of logical communication sessions supported over the first communication connection.

3. The system of claim 1, wherein the code includes a database associated with the external processor, the database including a data structure adapted to store data for authenticating the client and the internal processor.

4. The system of claim 1, wherein the code includes a database associated with the external processor, the database including a data structure adapted to map the second and third one of the plurality of ports to the internal processor to the first and second target device network sockets, respectively.

5. The system of claim 1, wherein the code includes a database associated with the internal processor, the database including a data structure adapted to store a network address and port number of the external processor and data for authenticating the internal processor.

6. The system of claim 1, wherein the first target device is at least one of a process controller, an energy use or management device, and a building automation device.

7. The system of claim 1, wherein the third communication connection includes an intermediate communication device.

8. A communication device for providing communication with a first client and a second client located outside of a network gateway and target devices located inside of the network gateway, comprising:
a processor;
a network adapter coupled to the processor; and
code associated with the processor and network adapter, the code including a shared secret, a network address and port number for the first client, and executable instructions; and
wherein the code enables:
the processor to initiate a first communication connection with the first client located outside of the network gateway, the first communication connection including a persistent transport layer session; and
upon the second client communicating with the first client and requesting access to the first target device:
the processor to initiate a second communication connection with a first target device; and
the processor to enable a logical third communication connection between the second client and the first target device using the first and second communication connection.

9. The communication device of claim 8, wherein the code further enables:
upon a third client communicating with the first client and requesting access to a second target device, the processor to initiate a fourth communication connection with the second target device; and
the processor to enable a logical fifth communication connection between the third client and the second target device using the first and fourth communication connection.

10. The communication device of claim 9, wherein the third and fifth communication connections can be concurrently supported as logical sessions within and transparent to the transport layer of the first communication connection.

11. The communication device of claim 8, wherein the code further enables the processor to initiate the second communication connection with the first target device by using an internal network address of the first target device, the internal network address selected from a database associating the first target device with a port of the first client, the port identified by having received the access request from the second client at that port.

12. The communication device of claim 11, wherein the first communication connection includes a TCP session, and the code further enables:
the processor to initiate the second communication connection between the communication device and the first target device upon the processor receiving an open command from the first client, the open command including internal network address of the first target; and
the processor to determine a communication protocol for the second communication connection not limited to the protocol(s) used for the first communication connection.

13. The communication device of claim 8, wherein the first target device is at least one of a process controller, an energy use or management device, and a building automation device.

14. A method of providing a reverse network connection through a network gateway securing a first network from access over a second network, comprising:
identifying a node number of an internal processor coupled to the first network;
providing to the internal processor a network address and connection port number of an external processor coupled to the second network;
providing to the external processor the node number of the internal processor and a plurality of network addresses corresponding to a plurality of target devices coupled to the first network; and
mapping in the external processor each of a plurality of ports of the external processor to the connection port number to one of the plurality of network addresses corresponding to one of the plurality of target devices.

15. The method of claim 14, further comprising the internal processor initiating a persistent transport layer session with the external processor.

16. The method of claim 15, further comprising:
receiving at a first one of the plurality of ports of the external processor, an access request from a first client coupled to the second network, the access request corresponding to a first one of the plurality of target devices logically associated by the mapping with the first one of the plurality of ports;
the external processor authenticating the first client;
the external processor verifying authorization of the first client to access a first target device; and
authorizing a first communication connection between the first client and the external processor.

17. The method of claim 16, further comprising:
the external processor sending over the persistent transport layer session an open command to the internal processor, the open command including the network address for the first target device;
the internal processor initiating a second communication connection between the internal processor and the first target device; and
enabling a logical third communication connection between the first client and the first target device using the first communication connection, the persistent transport layer session, and the second communication connection.

18. The method of claim 17, further comprising:
receiving at a second one of the plurality of ports of the external processor, an access request from a second client coupled to the second network, the access request corresponding to a second one of the plurality of the target devices logically associated by the mapping with the second one of the plurality of ports;
the external processor authenticating the second client;
the external processor and verifying authorization of the second client to access the second target device; and
authorizing a fourth communication connection between the second client and the external processor.

19. The method of claim 18, further comprising:
the external processor sending over the persistent transport layer session an open command to the internal processor, the open command including the network address for the second target device;
the internal processor initiating a fifth communication connection between the internal processor and the second target device; and
enabling a logical sixth communication connection between the second client and the second target device using the fourth communication connection, the persistent transport layer session, and the fifth communication connection, the logical sixth communication connection capable of being supported concurrent with the third communication connection.

20. The method of claim 19, wherein the enabling the logical third and sixth communication connections concurrently include the internal and external processor assigning a first logical session ID for controlling the data stream between the first and second communication connections and assigning a second logical session ID for controlling the data stream between the fourth and fifth communication connections, the first or second logical session IDs encapsulated within the respective data stream segments that are multiplexed over the persistent transport layer session.
